(19) United States
(12) Patent Application Publication
(10) Pub. No.: US 2018/0180091 A1
(43) Pub. Date: Jun. 28, 2018

(54) CONNECTION STRUCTURE AND ELECTRONIC DEVICE HAVING THE SAME

(71) Applicant: Lenovo (Beijing) Co., Ltd., Beijing (CN)

(72) Inventors: Junchao Luo, Beijing (CN); Chunyan Wang, Beijing (CN); Guijing Wang, Beijing (CN); Chunmei Guo, Beijing (CN)

(21) Appl. No.: 15/854,070

(22) Filed: Dec. 26, 2017

(30) Foreign Application Priority Data
Dec. 26, 2016 (CN) 201611220898.9

(51) Int. Cl. F16C 13/06; F16J 15/00; F16J 15/3232; F16J 15/3252

(52) U.S. Cl. CPC F16C 13/06; F16J 15/3252; F16J 15/3232; F16J 15/006

(57) ABSTRACT

A connection structure and an electronic device having the same are provided. The connection structure comprises a first driving unit including a first gear and a second gear that are connected coaxially, a radius of the first gear being different from a radius of the second gear; a second driving unit coupled to the first driving unit; a first rotation shaft operatively coupled to the first driving unit; and a second rotation shaft operatively coupled to the second driving unit. The first rotation shaft and the second rotation shaft rotate synchronously via actions of the first driving unit and the second driving unit.

### CROSS-REFERENCES TO RELATED APPLICATIONS

This application claims priority of Chinese Patent Application No. 201611220898.9, filed on Dec. 26, 2016, the entire contents of which are hereby incorporated by reference.

### FIELD OF THE INVENTION

The present disclosure generally relates to the field of electronic device manufacturing and, more particularly, relates to a connection structure and an electronic device having the same.

### BACKGROUND

In existing technologies, a connection structure often includes two gear shafts and a connection member located between the two gear shafts. The connection member is often a gear structure (e.g., an idle gear) engaged with the gears of the two gear shafts, respectively, thereby realizing the synchronous movement of the two gear shafts. However, the gears in the connection structure may occupy too much space, and when such connection structure is applied to an electronic device, the volume of the electronic device has to be large, resulting in low flexibility.

### BRIEF SUMMARY OF THE DISCLOSURE

One aspect of the present disclosure provides a connection structure. The disclosed connection structure comprises a first driving unit, a second driving unit, a first rotation shaft, and a second rotation shaft. The first driving unit includes a first gear and a second gear that are connected coaxially, and a radius of the first gear is different from a radius of the second gear. The second driving unit is coupled to the first driving unit. The first rotation shaft is coupled to the first driving unit, and the second rotation shaft is coupled to the second driving unit. The connection structure is configured to, when the first rotation shaft rotates, drive the second rotation shaft via the first driving unit and the second driving unit, so as to trigger the first rotation shaft and the second rotation shaft to rotate synchronously.

Another aspect of the present disclosure provides an electronic device. The electronic device comprises a first body, a second body, and at least one connection structure connecting the first body and the second body. The connection structure includes a first rotation shaft, a second rotation shaft, a first driving unit, and a second driving unit. The first driving unit further includes a first gear and a second gear that are connected coaxially, and a radius of the first gear is different from a radius of the second gear. The first driving unit is coupled to the second driving unit. The first rotation shaft is coupled to the first driving unit, and the second rotation shaft is coupled to the second driving unit. Further, the first rotation shaft and the second rotation shaft are coupled to the first body and the second body, respectively, so as to allow the first body to rotate and stops rotation at a first angle with respect to the second body.

Other aspects of the present disclosure can be understood by those skilled in the art in light of the description, the claims, and the drawings of the present disclosure.

### BRIEF DESCRIPTION OF THE DRAWINGS

In order to more clearly illustrate technical solutions in disclosed embodiments of the present invention, drawings necessary for the description of the embodiments or the prior art are briefly introduced below. Obviously, the drawings described below are only some embodiments of the present disclosure, and it is possible for those ordinarily skilled in the art to derive other drawings from these drawings without creative effort.

FIG. 1 illustrates a structural schematic view of a connection structure consistent with disclosed embodiments;

FIG. 2 illustrates a structural schematic view of a first rotation shaft and a second rotation shaft consistent with disclosed embodiments;

FIG. 3 illustrates a structural schematic view of a first driving unit consistent with disclosed embodiments;

FIG. 4 illustrates a structural schematic view of a first rotation shaft and a gear thereon consistent with disclosed embodiments;

FIG. 5 illustrates a structural schematic view of another connection structure consistent with disclosed embodiments;

FIG. 6 illustrates a structural schematic view of a gear box, a first rotation shaft and a second rotation shaft consistent with disclosed embodiments;

FIG. 7 illustrates another structural schematic view of a first driving unit and a second driving unit consistent with disclosed embodiments;

FIG. 8 illustrates a schematic view of an electronic device consistent with disclosed embodiments;

FIG. 9 illustrates another structural schematic view of an electronic device consistent with disclosed embodiments;

FIG. 10 illustrates another structural schematic view of an electronic device consistent with disclosed embodiments; and

FIG. 11 illustrates a structural schematic view of a second driving unit consistent with disclosed embodiments.

### DETAILED DESCRIPTION

The technical solutions in embodiments of the present disclosure will be described hereinafter with reference to the accompanying drawings. Obviously, the embodiments described below are merely a part of, rather than entire embodiments of the present disclosure. On the basis of the disclosed embodiments, other embodiments obtainable by those ordinarily skilled in the art without creative effort shall all fall within the scope of the present disclosure.

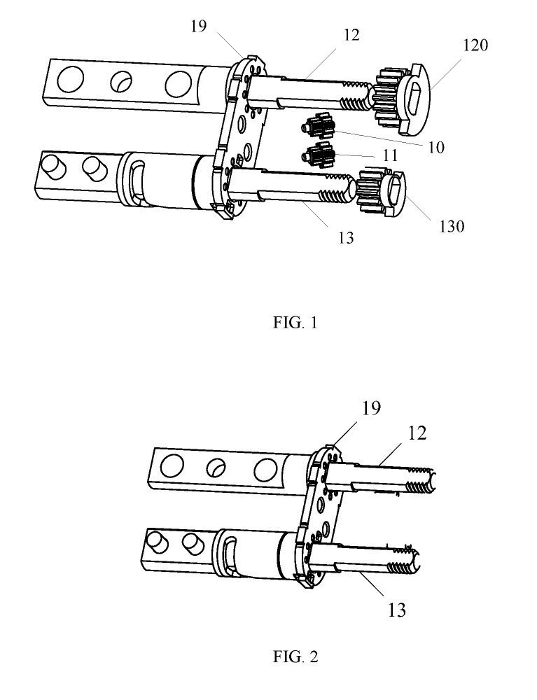

The present disclosure provides a connection structure. FIG. 1 illustrates a structural schematic view of a connection structure consistent with disclosed embodiments. In one embodiment, as shown in FIG. 1, the connection structure may include a first driving unit 10, a second driving unit 11, a first rotation shaft 12, and a second rotation shaft 13. Optionally, the connection structure may further include a fixed board 19, the first rotation shaft 12 may further comprise a first engagement gear 120, and the second rotation shaft 13 may further comprise a second engagement gear 130. Further, the first driving unit 10 may be the same as or different from the second driving unit 11.

FIG. 3 illustrates a first driving unit consistent with disclosed embodiments. As shown in FIG. 3, the first driving unit 10 may include: a first gear 100 and a second gear 101. The first gear 100 may be fixedly connected to the second gear 101, and a radius of the first gear 100 may be different from a radius of the second gear 101. For example, the radius of the first gear 100 may be smaller than the radius of the second gear 101.

Further, the first gear 100 and the second gear 101 included in the first driving unit 10 may have different numbers of gear teeth. That is, the first gear 100 and the second gear 101 included in the first driving unit 10 may have different gear radii and different numbers of gear teeth.

Further, the first driving unit 10 may be connected to the second driving unit 11. For example, the first driving unit 10 may have an end to be fastened to the fixed board 19, and the second driving unit 11 may have an end to be fastened to the fixed board 19, such that the first driving unit 10 and the second driving unit 11 may be connected indirectly via the fixed board 19.

Further, the second driving unit 11 may include one or more gears. Optionally, while the first gear 100 of the first driving unit 10 is engaged with first engagement gear 120 of the first rotation shaft 12 to receive a driving force, the second gear 101 of the first driving unit 10 may be engaged with a gear included in the second driving unit 11. By engagement between different gears with corresponding parameters, synchronous rotation or asynchronous rotation between the first driving unit 10 and the second driving unit 11 may be implemented.

Optionally, the second driving unit 11 may include a single gear. The gear of the second driving unit 11 may be engaged with the second gear 101 of the first driving unit 10, and be further engaged with the second engagement gear 130 of the second rotation shaft 13. Further, the gear of the second driving unit 11 may be configured to, when the first driving unit 10 rotates, drive the second rotation shaft 13 to rotate. That is, the second rotation shaft 13 may be triggered to rotate with the second driving unit 11 synchronously.

Optionally, the second driving unit 11 may include two gears. FIG. 11 illustrates a structural schematic view of a second driving unit consistent with disclosed embodiments. As shown in FIG. 11, the second driving unit 11 may include a third gear 110 and a fourth gear 111 that are coaxial and connected fixedly. The third gear 110 and the fourth gear 111 may have different radii. For example, the fourth gear 111 may be engaged with the second gear 101 of the first driving unit 10. When the second gear 101 of the first driving unit 10 rotates, the fourth gear 111 may rotate with the second gear 101 synchronously.

The third gear 110 may be engaged with the second engagement gear 130 of the second rotation shaft 13. Because the third gear 110 and the fourth gear 111 are coaxial, when the fourth gear 111 rotates, the third gear 110 may rotate synchronously and drive the second engagement gear 130 of the second rotation shaft 13 to rotate, thereby triggering the second rotation shaft 13 to rotate with the third gear 110.

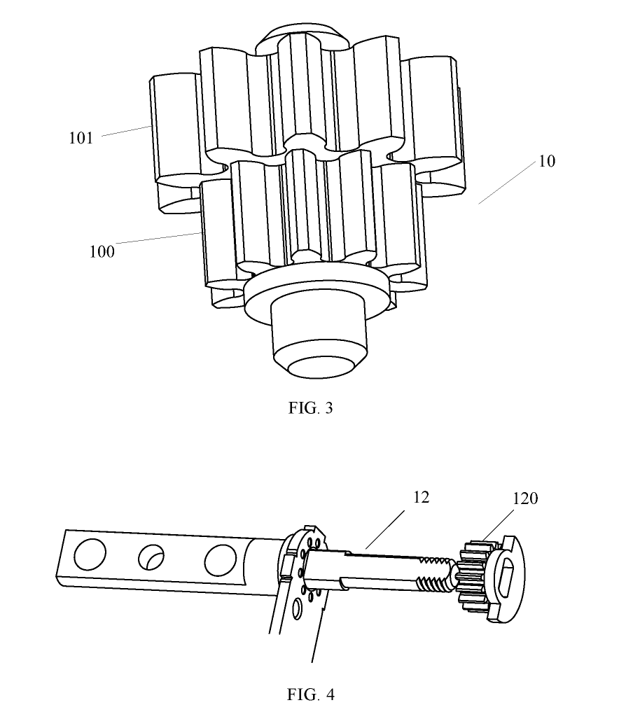

Further, the first driving unit 10 may be coupled to the first rotation shaft 12, and the second driving unit 11 may be coupled to the second rotation shaft 13. FIG. 2 illustrates a structural schematic view of a first rotation shaft and a second rotation shaft consistent with disclosed embodiments. Referring to FIG. 2 and FIG. 1, right portions of the first rotation shaft 12 and the second rotation shaft 13 may each include a threaded end. The right portion of the first rotation shaft 12 refers to the portion of the first rotation shaft 12 to the right of the fixed board 19, and the right portion of the second rotation shaft 13 refer to the portion of the second rotation shaft 13 to the right of the fixed board 19. The threaded end of the first rotation shaft 12 and the threaded end of the second rotation shaft 13 may be respectively used for fastening purposes with the help of a nut (not shown in FIG. 1).

Optionally, one or more holes, or one or more protrusions, or a combination thereof may be configured in in the left portion of the first rotation shaft 12, where referring to FIG. 1, the left portion of the first rotation shaft 12 refers to the portion of the first rotation shaft 12 to the left of the fixed board 19. Similarly, one or more holes, or one or more protrusions, or a combination thereof may be configured in in the left portion of the second rotation shaft 13, where referring to FIG. 1, the left portion of the second rotation shaft 13 refers to the portion of the second rotation shaft 13 to the left of the fixed board 19. Any of the holes may be threaded to hold a bolt, or the holes may have other functions.

For example, as shown in FIG. 1 and FIG. 2, one relatively small hole may be configured in approximately middle of the left portion of the first rotation shaft 12, and two relatively large holes may be configured on two sides of the relatively small hole. The two relatively large holes may each be inserted with a columnar member that has one end levelled with a surface of the left portion of the first rotation shaft 12. Further, two protrusions may be configured in the left portion of the second rotation shaft 13.

Further, the first rotation shaft 12 may be connected to the second rotation shaft 13. Referring to FIG. 1 and FIG. 2, the first rotation shaft 12 may be connected indirectly to the second rotation shaft 13 via the fixed board 19. That is, the fixed board 19 may be simultaneously sleeved on the first rotation shaft 12 and the second rotation shaft 13.

More specifically, in one example, two round-shaped holes with sizes respectively compatible with the dimensions of first rotation shaft 12 and the second rotation shaft 13 may be configured in the fixed board 19, thereby allowing the fixed board 19 to be simultaneously sleeved on the first rotation shaft 12 and the second rotation shaft 13. Further, in such a configuration, the first rotation shaft 12 and the second rotation shaft 13 may rotate with respect to the fixed board 19.

Further, the two holes may be in the same size or different sizes, depending on the dimensions of the first rotation shaft 12 and the second rotation shaft 13. Optionally, additional holes may be designed in the fixed board 19 to implement desired functions. For example, two relatively small holes may be configured between the two holes that hold the first rotation shaft 12 and the second rotation shaft 13, respectively. The two relatively small holes may be designed to respectively fasten an end of the first driving unit 10 and an end of the second driving unit 11.

That is, the first driving unit 10 and the second driving unit 11 may be inserted to the two relatively small holes and be further fastened to the fixed board 19. Optionally, a line connecting the centers of the two relatively small holes may not be parallel to a line connecting the centers of the two holes that hold the first rotation shaft 12 and the second rotation shaft 13, respectively.

Further, the first rotation shaft 12 may include a gear (e.g., the first engagement gear 120) to be engaged with the first gear 100 of the first driving unit 10. The gear of the first rotation shaft 12 may be configured to, when the first rotation shaft 12 rotates, trigger the first driving unit 10 to rotate with the first rotation shaft 12 synchronously.

More specifically, the first rotation shaft 12 including the gear to be engaged with the first gear 100 of the first driving unit 10 may refer to a situation where the first rotation shaft 12 is fixedly connected to the first engagement gear 120. Optionally, the first engagement gear 120 may not be fixedly connected to the first rotation shaft 12. For example, FIG. 4 illustrates a structural schematic view of a first rotation shaft and a gear thereon consistent with disclosed embodiments. As shown in FIG. 4, the first engagement gear 120 is sleeved on the first rotation shaft 12, and the first engagement gear 120 rotates when the first rotation shaft 12 rotates.

Further, the second rotation shaft 13 may include a gear (e.g., the second engagement gear 130) to be engaged with a gear of the second driving unit 11. The same gear or a different gear of the second driving unit 11 may be engaged with the second gear 101 of the first driving unit 10. Accordingly, the second driving unit 11 may be configured to, when the first driving unit 10 rotates, drive the second rotation shaft 13 to rotate via the gear included in the second rotation shaft 13. That is, the second rotation shaft 13 may be triggered to rotate with the second driving unit 11 synchronously.

More specifically, the second rotation shaft 13 including the gear to be engaged with a gear of the second driving unit 11 may refer to a situation where the second rotation shaft 13 is fixedly connected to the second engagement gear 130. Optionally, the second engagement gear 130 may not be fixedly connected to the second rotation shaft 13. For example, the second engagement gear 130 may be sleeved on the second rotation shaft 13, and the second engagement gear 130 may rotate when the second rotation shaft 13 rotates.

As such, the connection structure is configured to, when the first rotation shaft 12 rotates, drive the second rotation shaft 13 to rotate via the first driving unit 10 and the second driving unit 11. That is, by using the disclosed connection structure, the second rotation shaft 13 may be triggered to rotate with the first rotation shaft 12 synchronously.

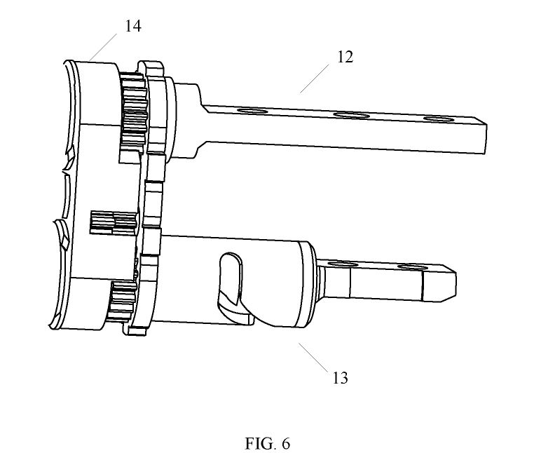

FIG. 6 illustrates a structural schematic view of a gear box, a first rotation shaft and a second rotation shaft consistent with disclosed embodiments. As shown in FIG. 6, the connection structure may further include a gear box 14, and the gear box 14 may at least be configured to sleeve the first driving unit 10 and the second driving unit 11 thereon. The first rotation shaft 12 and the second rotation shaft 13 may rotate with respect to the gear box 14.

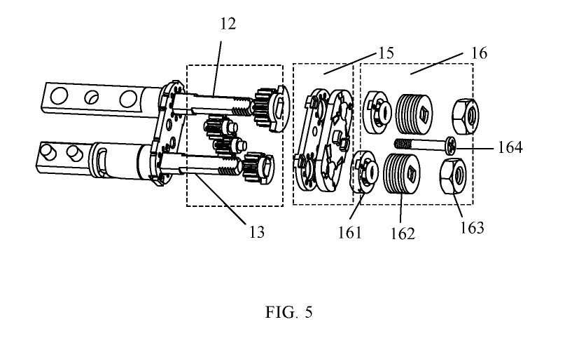

FIG. 5 illustrates a structural schematic view of another connection structure consistent with disclosed embodiments, as shown in FIG. 5, the connection structure may further include at least two gaskets 15. The at least two gaskets 15 may be sleeved on the first rotation shaft 12 and the second rotation shaft 13, respectively. The at least two gaskets 15 may assist to fix the relative positions of the first rotation shaft 12 and the second rotation shaft 13 with respect to the gear box 14.

Further, the first engagement gear 120 of the first rotation shaft 12 may be engaged with the first gear 100 of the first driving unit 10 for synchronous rotation. Thus, the first driving unit 10 may rotate with the first rotation shaft 12 synchronously. Because the second gear 101 of the first driving unit 10 may be engaged with the fourth gear 111 of the second driving unit 11, the first driving unit 10 may drive the second driving unit 11 to rotate synchronously. Further, because the third gear 110 of the second driving unit 11 may be engaged with the second engagement gear 130 of the second rotation shaft 13, the second driving unit 11 may drive the second rotation shaft 13 to rotate synchronously. Accordingly, the first rotation shaft 12, the first driving unit 10, the second driving unit 11, and the second rotation shaft 13 may rotate synchronously.

In the disclosed embodiment, because the first driving unit 11 and the second driving unit 12 may include gears connected coaxially that have different radii, the dimensions of the first driving unit 10 and the second driving unit 11 may be largely decreased. Thus, the volume of the electronic device to which the connection structure applies is reduced, and the flexibility of the electronic device to which the connection structure applies may be improved.

In another embodiment, referring to FIG. 1, the connection structure may include a first driving unit 10, a second driving unit 11, a first rotation shaft 12, and a second rotation shaft 13. The first driving unit 10 may be coupled to the second driving unit 11. The first rotation shaft 12 may be coupled to the first driving unit 10, and the second rotation shaft 13 may be coupled to the second driving unit 11.

In one example, as shown in FIG. 2, the fixed board 19 may be simultaneously sleeved on the first rotation shaft 12 and the second rotation shaft 13, such that the first rotation shaft 12 is connected to the second rotation shaft 13 indirectly. The first driving unit 10 may be connected indirectly to the second driving unit 11 via the fixed board 19.

The first driving unit 10 may include: a first gear 100 and a second gear 101. The first gear 100 may be fixedly connected to the second gear 101, and a radius of the first gear 100 may be different from a radius of the second gear 101.

Further, as shown in FIG. 3, the first gear 100 and the second gear 101 included in the first driving unit 10 may have different gear radii and different numbers of gear teeth. By engagement between different gears with corresponding parameters, synchronous rotation or asynchronous rotation between the first driving unit 10 and the second driving unit 11 may be implemented.

The connection structure is configured to, when the first rotation shaft 12 rotates, drive the second rotation shaft 13 to rotate via the first driving unit 10 and the second driving unit 11, thereby triggering the second rotation shaft 13 to rotate with the first rotation shaft 12 synchronously.

Optionally, the first rotation shaft 12 may include a gear (e.g., the first engagement gear 120) to be engaged with the first gear 100 of the first driving unit 10. The gear of the first rotation shaft 12 may be configured to, when the first rotation shaft 12 rotates, trigger the first driving unit 10 to rotate with the first rotation shaft 12 synchronously.

More specifically, the first rotation shaft 12 including a gear to be engaged with the first gear 100 of the first driving unit 10 may refer to a situation where the first engagement gear 120 is fixedly connected to first rotation shaft 12. Optionally, the first rotation shaft 12 may not be fixedly connected to the first engagement gear 120. For example, the first engagement gear 120 may be sleeved on the first rotation shaft 12, and the first engagement gear 120 may rotate as the first rotation shaft 12 rotates.

In one implementation, the second rotation shaft 13 may comprise a gear (e.g., the second engagement gear 130) to be engaged with a gear of the second driving unit 11. Further, the gear of the second driving unit 11 may be engaged with the second gear 101 of the first driving unit 10, and may be configured to, when the first driving unit 10 rotates, drive the second rotation shaft 13 to rotate. That is, the second rotation shaft 13 may be triggered to rotate with the second driving unit 11 synchronously.

More specifically, the second rotation shaft 13 including the second engagement gear 130 to be engaged with a gear of the second driving unit 11 may refer to a situation where the second rotation shaft 13 is fixedly connected to the second engagement gear 130, and the second engagement gear 130 is engaged with a gear of the second driving unit 11. Optionally, the second engagement gear 130 may not be fixedly connected to the second rotation shaft 13. That is, the second engagement gear 130 may be sleeved on the second rotation shaft 13, and the second engagement gear 130 may rotate as the second rotation shaft 13 rotates.

Optionally, as shown in FIG. 11, the second driving unit 11 may include a third gear 110 and a fourth gear 111 that are coaxial and fixedly connected. The third gear 110 and the fourth gear 111 may have different radii. The fourth gear 111 may be engaged with the second gear 101 of the first driving unit 10, and when the second gear 101 of the first driving unit 10 rotates, the fourth gear 111 of the second driving unit 111 may rotate synchronously.

The third gear 110 of the second driving unit 11 may be engaged with the gear 130 of the second rotation shaft 13. Because the third gear 110 and the fourth gear 111 have a coaxial relationship, when the fourth gear 111 rotates, the third gear 110 may rotate synchronously and drive the second rotation shaft 13 to rotate, thereby triggering the second rotation shaft 13 to rotate with the third gear 110 synchronously.

Referring to FIG. 6, the connection structure may further include a gear box 14, and the gear box 14 may at least be configured to sleeve the first driving unit 10 and the second driving unit 11 thereon. Further, the first rotation shaft 12 and the second rotation shaft 13 may rotate with respect to the gear box 14.

Further, as shown in FIG. 5, the connection structure may further include at least two gaskets 15. The at least two gaskets 15 may be sleeved on the first rotation shaft 12 and the second rotation shaft 13, respectively. The at least two gaskets 15 may assist to fix the positions of the first rotation shaft 12 and the second rotation shaft 13 with respect to the gear box 14. Further, to mount the first rotation shaft 12 and the second rotation shaft 13 fixedly, in actual applications, a fixation & connection assisting unit 16, etc. may be needed.

For example, the fixation & connection assisting unit 16 may include two first fastening elements 161, two second fastening elements 162, two nuts 163, and one or more bolts 164. Optionally, the first fastening elements 161 may be fend washers, and the second fastening elements 162 may be sleeves or bearings. The two nuts 163 may be six-sided nuts, and may be respectively inserted to an end of first rotation shaft 12 and an end of the second rotation shaft 13 that are threaded for fastening purposes.

In the disclosed embodiment, the first engagement gear 120 of the first rotation shaft 12 may be engaged with the first gear 100 of the first driving unit 10 to perform synchronous rotation. Thus, the first driving unit 10 may rotate synchronously with the first rotation shaft 12. Because the second gear 101 of the first driving unit 10 may be engaged with the fourth gear 111 of the second driving unit 11, the first driving unit 10 may drive the second driving unit 11 to perform synchronous rotation. Because the third gear 110 of the second driving unit 11 may be engaged with the second engagement gear 130 of the second rotation shaft 13, the second driving unit 11 may drive the second rotation shaft 13 to rotate synchronously. Accordingly, the first rotation shaft 12, the first driving unit 10, the second driving unit 11, and the second rotation shaft 13 may rotate synchronously.

In one implementation, as shown in FIG. 6, the connection structure may include at least one gear rotation shaft. Further, the position relationship between the first driving unit 10/the second driving unit 11 (not shown in FIG. 6) and the gear rotation shaft that runs through the gear box 14 is illustrated in FIG. 6.

In the disclosed embodiment, because the first driving unit 10 and the second driving unit 11 may include gears connected coaxially that have different radii, the dimensions of the first driving unit 10 and the second driving unit 11 may be greatly reduced. Thus, the volume of the electronic device to which the connection structure applies is reduced, and the flexibility of the electronic device to which the connection structure applies is improved.

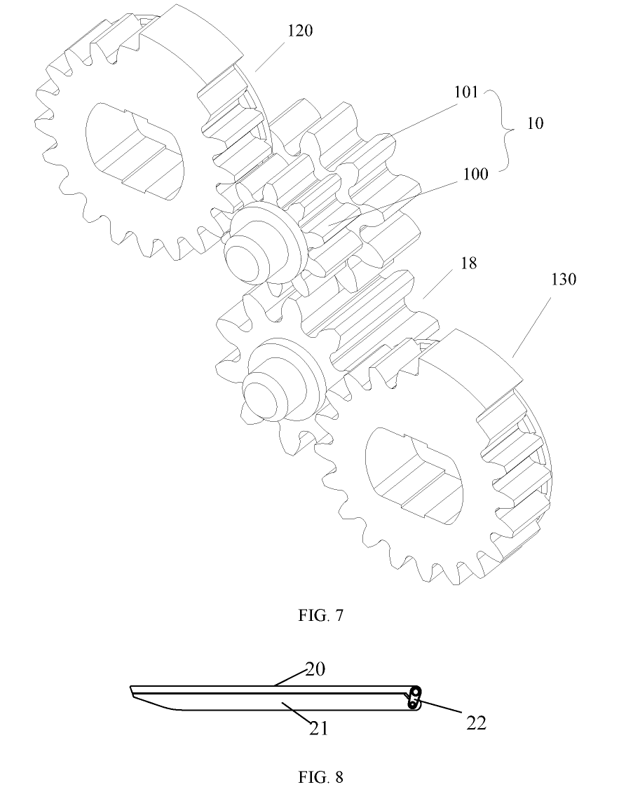

In another embodiment, the disclosed connection structure may include a first driving unit 10, a second driving unit 18, a first rotation shaft 12, and a second rotation shaft 13. FIG. 7 illustrates a structural schematic view of a first driving unit 10 and a second driving unit 18 consistent with disclosed embodiments. As shown in FIG. 7, the first driving unit 10 may be coupled to the second driving unit 18.

Further, the first rotation shaft 12 may be coupled to the first driving unit 10, and the second rotation shaft 13 may be coupled to the second driving unit 18. In one example, similar to that shown in FIG. 2, the first rotation shaft 12 may be connected to the second rotation shaft 13 indirectly via a fixed board. Further, the first driving unit 10 and the second driving unit 11 may be connected indirectly via the fixed board.

The first driving unit 10 may include: a first gear 100 and a second gear 101. The first gear 100 may be fixedly connected to the second gear 101, and a radius of the first gear 100 may be different from a radius of the second gear 101.

The specific structural schematic view of the first driving unit 10 may be referred to FIG. 3. As shown in FIG. 3, the first gear 100 and the second gear 101 included in the first driving unit 10 may have different gear radii and different numbers of gear teeth. By engagement between different gears with corresponding parameters, synchronous rotation or asynchronous rotation between the first driving unit 10 and the second driving unit 18 may be implemented.

The connection structure is configured to, when the first rotation shaft 12 rotates, drive the second rotation shaft 13 to rotate via the first driving unit 10 and the second driving unit 11. That is, the first rotation shaft 12 may rotate to trigger the second rotation shaft 13 to rotate with the first rotation shaft 12 synchronously.

In one example, the first rotation shaft 12 may include a first engagement gear 120 to be engaged with the first gear 100 of the first driving unit 10. The first engagement gear 120 of the first rotation shaft 12 may be configured to, when the first rotation shaft 12 rotates, trigger the first driving unit 10 to rotate with the first rotation shaft 12 synchronously.

More specifically, the first rotation shaft 12 including the first engagement gear 120 to be engaged with the first gear 100 of the first driving unit 10 may specifically refer to: the first rotation shaft 12 is fixedly connected to the first engagement gear 120, and the first engagement gear 120 is engaged with the first gear 100 of the first driving unit 10. Optionally, the first rotation shaft 12 may not be fixedly connected to the first engagement gear 120, as shown in FIG. 4, the first engagement gear 120 of the first rotation shaft 12 to be engaged with the first gear 100 of the first driving unit 10 may be sleeved on the first rotation shaft 12, and may rotate as the first rotation shaft 12 rotates.

Further, the second rotation shaft 13 may comprises a second engagement gear 130 to be engaged with the second driving unit 18, and the second driving unit 18 may be engaged with the second gear 101 of the first driving unit 10. For example, the second rotation shaft 13 may comprise a second engagement gear 130 to be engaged with a gear of the second driving unit 18, and the same gear or a different gear of the second driving unit 18 may be engaged with the second gear 101 of the first driving unit 10. When the first driving unit 10 rotates, the gear(s) of the second driving unit 18 may rotate, thereby driving the second rotation shaft 13 to rotate. That is, the gear(s) of the second driving unit 18 may trigger the second rotation shaft 13 to rotate with the second driving unit 18 synchronously.

More specifically, the second rotation shaft 13 including the second engagement gear 130 to be engaged with a gear of the second driving unit 18 may refer to a situation where the second rotation shaft 13 is fixedly connected to the second engagement gear 130. Optionally, the second rotation shaft 13 may not be fixedly connected to the second engagement gear 130. For example, the second engagement gear 130 may be sleeved on the second rotation shaft 13, and rotate as the second rotation shaft 13 rotates.

Further, while a gear of the second driving unit 18 may be engaged with the second engagement gear 130 of the second rotation shaft 13, the same or a different gear of the second driving unit 18 may be engaged with the second gear 101 of the first driving unit 10. Via the aforementioned gear engaging relationship, the synchronous rotation of the first rotation shaft 12 and the second rotation shaft 13 may be implemented.

In one example, the connection structure may further include a gear box 14, and the gear box 14 may at least be configured to sleeve the first driving unit 10 and the second driving unit 18 thereon. The first rotation shaft 12 and the second rotation shaft 13 may rotate with respect to the gear box 14.

Because the first driving unit 11 include two gears with different radii that are connected coaxially, the dimension of the driving unit 11 is greatly decreased. Thus, the volume of the electronic device to which the connection structure applies is reduced, and the flexibility of the electronic device to which the connection structure applies is improved.

The present disclosure further provides an electronic device. FIG. 8 illustrates a side view of an electronic device consistent with disclosed embodiments. As shown in FIG. 8, the electronic device may include: a first body 20, a second body 21, and at least one connection structure 22 connecting the first body 20 and the second body 21. The disclosed electronic device may be a laptop, a tablet, a cellphone, etc.

The connection structure 22 may be any aforementioned connection structure. For example, referring to FIG. 1, the connection structure 22 may include: a first driving unit 10, a second driving unit 11, a first rotation shaft 12, and a second rotation shaft 13. The first driving unit may be coupled to the second driving unit, for example, via a fixed board. The first rotation shaft 12 may be coupled to the first driving unit 10, and the second rotation shaft 13 may be coupled to the second driving unit 11.

The first rotation shaft 12 and the second rotation shaft 13 may be further coupled to the first body 20 and the second body 21, respectively, such that the first body 20 may rotate with respect to the second body 21. Further, the disclosed connection structure 22 may allow the first body 20 and the second body 21 to form and stay at a first angle. The first angle may be any angle within approximately 0 degree to 360 degree.

The first driving unit 10 may include: a first gear 100 and a second gear 101. The first gear 100 and the second gear 101 may be coaxial. Further, the first gear 100 may be fixedly connected to the second gear 101, and a radius of the first gear 100 may be different from a radius of the second gear 101.

Referring to FIG. 2, the first gear 100 and the second gear 101 included in the first driving unit 10 may have different gear radii and different numbers of gear teeth. By varying the parameters of the gears that are engaged, synchronous rotation or asynchronous rotation between the first driving unit 10 and the second driving unit 11 may be implemented.

The connection structure 22 is configured to, when the first rotation shaft 12 rotates, drive the second rotation shaft 13 to rotate via the first driving unit 10 and the second driving unit 11. That is, when the first rotation shaft 12 rotates, the second rotation shaft 13 may be triggered to rotate with the first rotation shaft 12 synchronously.

In one example, the first rotation shaft 12 may include a first engagement gear to be engaged with the first gear 100 of the first driving unit 10. The first engagement gear of the first rotation shaft 12 may be configured to, when the first rotation shaft 12 rotates, trigger the first driving unit 10 to rotate with the first rotation shaft 12 synchronously.

More specifically, the first engagement gear included in the first rotation shaft 12 that is engaged with the first gear 100 of the first driving unit 10 may be fixedly connected to the first rotation shaft 12. Optionally, as illustrated in FIG. 4, the first engagement gear may be sleeved on the first rotation shaft 12, and may rotate as the first rotation shaft 12 rotates.

Further, the second rotation shaft 13 may comprise a second engagement gear to be engaged with the second driving unit 11, and the second driving unit 11 may be engaged with the second gear 101 of the first driving unit 10. For example, the second rotation shaft 13 may comprise a second engagement gear to be engaged with a gear of the second driving unit 11, and the same or a different gear of the second driving unit 11 may be engaged with the second gear 101 of the first driving unit 10. Thus, the second driving unit 11 may be configured to, when the first driving unit 10 rotates, drive the second rotation shaft 13 to rotate. That is, the second rotation shaft 13 may be triggered to rotate with the second driving unit 11 synchronously.

More specifically, the second rotation shaft 13 including a second engagement gear to be engaged with a gear of the second driving unit 11 may include a situation where the second rotation shaft 13 is fixedly connected to the second engagement gear 130. Optionally, the second rotation shaft 13 may not be fixedly connected to the second engagement gear 130. For example, the second engagement gear included in the second rotation shaft 13 may be sleeved on the second rotation shaft 13. Further, the second engagement gear of the second rotation shaft 13 may rotate when the second rotation shaft 13 rotates.

Optionally, the second driving unit 11 may include a third gear 110 and a fourth gear 111 that are coaxial and fixedly connected. The third gear 110 and the fourth gear 111 may have different radii. The fourth gear 111 may be engaged with the second gear 101 of the first driving unit 10. Thus, when the second gear 101 of the first driving unit 10 rotates, the fourth gear 111 of the second driving unit 11 may be driven to rotate synchronously.

The third gear 110 may be engaged with the second engagement gear 130 of the second rotation shaft 13. Because the third gear 110 and the fourth gear 111 have a coaxial relationship, when the fourth gear 111 rotates, the third gear 110 may rotate synchronously and drive the second rotation shaft 13 to rotate. That is, the second rotation shaft 13 may be triggered to rotate with the third gear 110 synchronously.

Optionally, the connection structure 22 may further include a gear box 14, and the gear box 14 may at least be configured to sleeve the first driving unit 10 and the second driving unit 11 thereon. The first rotation shaft 12 and the second rotation shaft 13 may rotate with respect to the gear box 14.

Optionally, as shown in FIG. 5, the connection structure may further include at least two gaskets 15. The at least two gaskets 15 may be sleeved on the first rotation shaft 12 and the second rotation shaft 13, respectively. The at least two gaskets 15 may assist to fix relative positions of the first rotation shaft 12 and the second rotation shaft 13 with respect to the gear box 14. Further, to enable further fixation of the first rotation shaft 12 and the second rotation shaft 13, in actual applications, the fixation connection assisting member 16, etc., may need to be configured.

Optionally, the first engagement gear 120 of the first rotation shaft 12 may be engaged with the first gear 100 of the first driving unit 10 for synchronous rotation. Thus, the first driving unit 10 may rotate with the first rotation shaft 12 synchronously. Because the second gear 101 of the first driving unit 10 may be engaged with the fourth gear 111 of the second driving unit 11, the first driving unit 10 may drive the second driving unit 11 to rotate synchronously. Because the third gear 110 of the second driving unit 11 is engaged with a gear (i.e., the second engagement gear 130) of the second rotation shaft 13, the second driving unit 11 may drive the second rotation shaft 13 to rotate synchronously. Accordingly, the first rotation shaft 12, the first driving unit 10, the second driving unit 11, and the second rotation shaft 13 may rotate synchronously.

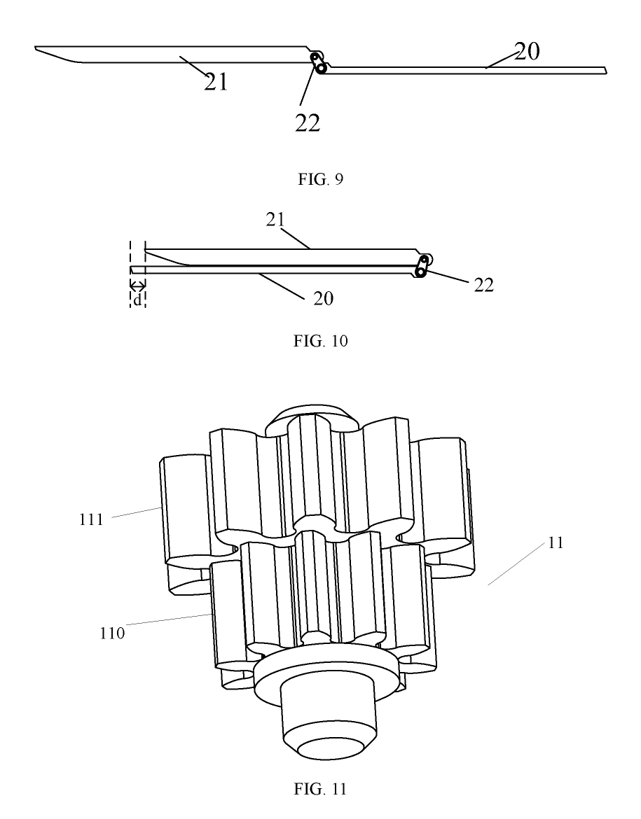

Further, the disclosed first body 20 and the second body 21 may be connected via the connection structure 22. As shown in FIG. 8, when the angle between the first body 20 and the second body 21 is 0, a first surface of the first body 20 and a first surface of the second body 21 may coincide. FIG. 9 illustrates another structural schematic view of an electronic device consistent with disclosed embodiments. FIG. 10 illustrates another structural schematic view of an electronic device consistent with disclosed embodiments.

As shown in FIG. 9, the first body 20 may rotate with respect to the second body 21 and stops rotation when a second surface of the first body 20 is parallel to a second surface of the second body 21. Further, as shown in FIG. 10, the first body 20 may continue to rotate with respect to the second body 21 until the second surface of the first body 20 gets in touch with the second surface of the second body 21.

Optionally, as shown in FIG. 10, when the first body 20 rotates until the second surface of the first body 20 is in touch with the second surface of the second body 21, the second surface of the first body 20 may not completely coincide with the second surface of the second body 21. That is, referring to FIG. 10, the leftmost side of the second surface of the first body 20 may show a distance of d to the leftmost side of the second surface of the second body 21.

In actual applications, the first body 20 may specifically be a part where a display screen is located, and the first surface of the first body 20 may be a surface where the display screen is. The second surface of the first body 20 may specifically be a surface of the first body 20 that corresponds to the display screen. For example, the second body 21 may specifically be a part where a keyboard is. A first surface of the second body 21 may specifically be a surface where the keyboard is, and the second surface of the second body 21 may be a surface of the second part 21 opposite to the keyboard.

As such, in the disclosed electronic device, the angle between the first body 20 and the second part 21 may be varied or maintained at an angle (e.g., the first angle) via the connection structure 22. That is, the first body 20 may rotate with respect to the second part 21, or the second part 21 may rotate with respect to the first body 20. Because the first driving unit 10 and the second driving unit 11 in the connection structure 22 may respectively include two gears connected coaxially and having different radii, the dimensions of the driving unit 10 and the driving unit 11 may be greatly decreased. Accordingly, the volume of the electronic device is reduced, and the flexibility of the electronic device is improved.

Various embodiments of the present specification are described in a progressive manner, each embodiment may have its difference from other embodiments, and features of different embodiments may be combined together in any appropriate manner or may be separated from each other.

The above specification that discloses various embodiments in intended for those skilled in the art to practice or use this invention. Various modifications of these embodiments are apparent to those skilled in the art, and the basic principles defined in this paper can be realized in other embodiments without departing from the spirit or scope of this invention. As such, this invention will not be limited to the disclosed embodiments, but rather it is intended to satisfy the widest range that is consistent with the principles and novel ideas made common by this invention.

What is claimed is:

1. A connection structure, comprising:
a first driving unit including a first gear and a second gear that are connected coaxially, a radius of the first gear being different from a radius of the second gear;
a second driving unit coupled to the first driving unit;
a first rotation shaft operatively coupled to the first driving unit; and
a second rotation shaft operatively coupled to the second driving unit,
wherein the first rotation shaft and the second rotation shaft rotate synchronously via actions of the first driving unit and the second driving unit.

2. The connection structure according to claim 1, wherein:
the first rotation shaft comprises a first engagement gear engaged with the first gear of the first driving unit, and
in response to rotation of the first rotation shaft, the first engagement gear triggers the first driving unit to rotate with the first rotation shaft.

3. The connection structure according to claim 2, wherein:
the second rotation shaft comprises a second engagement gear engaged with the second driving unit;
the second driving unit is engaged with the second gear of the first driving unit, and
in response to rotation of the first rotation shaft, the second driving unit drives the second rotation shaft to rotate with the first rotation shaft.

4. The connection structure according to claim 3, wherein:
the second driving unit comprises a third gear and a fourth gear that are connected coaxially,
a radius of the third gear is different from a radius of the fourth gear,
the fourth gear is engaged with the second gear of the first driving unit, and in response to rotation of the second gear of the first driving unit, the fourth gear rotates with the second gear of the first driving unit, and
the third gear is engaged with the second engagement gear of the second rotation shaft, and in response to rotation of the fourth gear, the third gear drives the second engagement gear of the second rotation shaft to rotate with the third gear.

5. The connection structure according to claim 1, wherein:
the connection structure further comprises a gear box,
the gear box sleeves the first driving unit and the second driving unit, and
the first rotation shaft and the second rotation shaft rotate with respect to the gear box.

6. The connection structure according to claim 1, wherein:
the connection structure further includes two gaskets,
the two gaskets are sleeved on the first rotation shaft and the second rotation shaft, respectively, and
relative positions of the first rotation shaft and the second rotation shaft with respect to a gear box are fixed via the two gaskets.

7. An electronic device, comprising:
a first body;
a second body; and
at least one connection structure connecting the first body and the second body,
wherein:
the connection structure includes a first rotation shaft, a second rotation shaft, a first driving unit, and a second driving unit,
the first driving unit is operatively coupled to the second driving unit,
the first rotation shaft is operatively coupled to the first driving unit,
the second rotation shaft is coupled to the second driving unit, and
the first rotation shaft and the second rotation shaft are further coupled to the first body and the second body, respectively, to allow the first body to rotate and stop rotation at a first angle with respect to the second body.

8. The electronic device according to claim 7, wherein:
the first driving unit includes a first gear and a second gear that are connected coaxially,
a radius of the first gear is different from a radius of the second gear,
the first rotation shaft comprises a first engagement gear engaged with the first gear of the first driving unit, and
in response to rotation of the first rotation shaft, the first engagement gear included in the first rotation shaft rotates the first driving unit with the first rotation shaft.

9. The electronic device according to claim 8, wherein:
the second rotation shaft comprises a second engagement gear to be engaged with the second driving unit;
the second driving unit is engaged with the second gear of the first driving unit; and
in response to rotation of the first driving unit, the second driving unit drives the second rotation shaft, rotating the second rotation shaft with the second driving unit.

10. The electronic device according to claim 9, wherein:
the second driving unit comprises a third gear and a fourth gear that are connected coaxially,
a radius of the third gear is different from a radius of the fourth gear,
the fourth gear is engaged with the second gear of the first driving unit, and in response to rotation of the second gear of the first driving unit, the fourth gear rotates with the second gear of the first driving unit rotates, and
the third gear is engaged with the second engagement gear of the second rotation shaft, and in response to rotation of the fourth gear, the third gear drives the second engagement gear of the second rotation shaft, rotating the second rotation shaft to rotate with the third gear.

11. The electronic device according to claim 7, wherein:
the connection structure further comprises a gear box,
the gear box sleeves the first driving unit and the second driving unit thereon, and
the first rotation shaft and the second rotation shaft rotate with respect to the gear box.

12. The electronic device according to claim 7, wherein:
the connection structure further includes two gaskets,
the two gaskets are sleeved on the first rotation shaft and the second rotation shaft, respectively, and
relative positions of the first rotation shaft and the second rotation shaft with respect to a gear box are fixed via the two gaskets.
